(19) United States
(12) Patent Application Publication
(10) Pub. No.: US 2007/0279288 A1
(43) Pub. Date: Dec. 6, 2007

(54) Antenna

(76) Inventor: Chih-Kai Liu, Taipei Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/512,290

(22) Filed: Aug. 30, 2006

(30) Foreign Application Priority Data
May 30, 2006 (TW) 95119253

(51) Int. Cl. H01Q 1/38

(52) U.S. Cl. 343/700 MS; 343/702

(57) ABSTRACT

An antenna includes a grounding element, a radiating element and a coupling element. The radiating element has a radiating part and a connecting part. The connecting part connects the grounding element and the radiating part. The coupling element extends from the grounding element and is positioned between the radiating element and the grounding element.

### RELATED APPLICATIONS

The present application is based on, and claims priority from, Taiwan Application Serial Number 95119253, filed May 30, 2006, the disclosure of which is hereby incorporated by reference herein in its entirety.

### BACKGROUND

1. Field of Invention

The present invention relates to an antenna. More particularly, the present invention relates to an antenna with a coupling element.

2. Description of Related Art

As the rapid development of wireless communication technologies, many electronic apparatus, such as mobile phones, computers and network applications use wireless communication technologies to communicate with each other, wireless wide area network (WWAN) especially. More and more manufacturers want to incorporate WWAN into consumer electronic products because WWAN can provide communication within a local, nationwide or even global area.

A typical receiving or transmitting wireless communication device includes a receiver or a transmitter and an antenna mounted thereon. The antenna is a terminal that transmits or receives an electromagnetic wave. The antenna should be designed carefully to radiate electromagnetic waves effectively. The antenna seriously affects the performance of the whole wireless network application. Therefore, designing a standard compatible and useful antenna is very important.

All wireless communication technologies like WWAN have numerous wireless communication standards. Typically, one antenna is compatible with one specific wireless communication standard only due to the narrow band of the antenna. Therefore, in order to be compatible with more wireless communication standards, many manufacturers configure two or more antennas with different standards into a consumer electronic product. However, two or more antennas consume a lot of space and interfere with each other.

For the foregoing reasons, there is a need to develop a broad band antenna compatible with more wireless communication standards for manufacturers, sales and consumers.

### SUMMARY

It is therefore an aspect of the present invention to provide an antenna, which employs a coupling element to resonate with another band.

According to one preferred embodiment of the present invention, an antenna includes a grounding element, a radiating element and a coupling element. The radiating element has a radiating part and a connecting part. The connecting part connects the grounding element and the radiating part. The coupling element extends from the grounding element, and the coupling element is positioned between the radiating element and the grounding element. When a current is fed into the radiating element, a residue current is generated on the grounding element. Thus, the radiating element resonates with one band when the current passes through the radiating element, and the coupling element can resonate with another band as well when the residue current passes through the coupling element.

It is another aspect of the present invention to provide an antenna, which uses a residue current to have another band, wherein the residue current is generated somewhere near the feed of the antenna and on the grounding element.

According to another preferred embodiment of the present invention, an antenna includes a grounding element, a radiating element, a feed and a coupling element. The radiating element has a radiating part and a connecting part. The connecting part connects the grounding element and the radiating part. The feed is disposed on the connecting part. The coupling element extends from the grounding element, and the coupling element is positioned near the feed. When a current is fed into the radiating element, a residue current is generated somewhere near the feed of the antenna and on the grounding element. Thus, the radiating element resonates with one band when the current passes through the radiating element, and the coupling element can resonate with another band as well when the residue current passes through the coupling element.

Therefore, the antenna according to the mentioned embodiments of the present invention employs the coupling element to resonate with another band such that the antenna can have a broad band to be compatible with more wireless communication standards. Moreover, the consumer electronic product with the antenna does not have to have multiple antennas built therein due to the broad band of the antenna, and thus inference between the antennas no longer occurs.

It is to be understood that both the foregoing general description and the following detailed description are by examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a side view of an antenna according to one preferred embodiment of the present invention;

FIG. 2 is a three dimensional view of an antenna according to another preferred embodiment of the present invention;

FIG. 3 is a side view of an antenna according to a contrastive example;

FIG. 4 is a diagram showing a curve of voltage standing wave ratio (VSWR) vs. frequency for the antenna 300 shown in FIG. 3; and

FIG. 5 is a diagram showing a curve of VSWR vs. frequency for the antenna 100 shown in FIG. 1.

### DESCRIPTION OF THE PREFERRED EMBODIMENTS

The present invention provides an antenna, which employs a coupling element to resonate with another band, such that the antenna can have a broad band to be compatible with more wireless communication standards. Reference will now be made in detail to the present preferred embodiments of the invention, examples of which are illustrated in the accompanying drawings. Wherever possible, the same reference numbers are used in the drawings and the description to refer to the same or like parts.

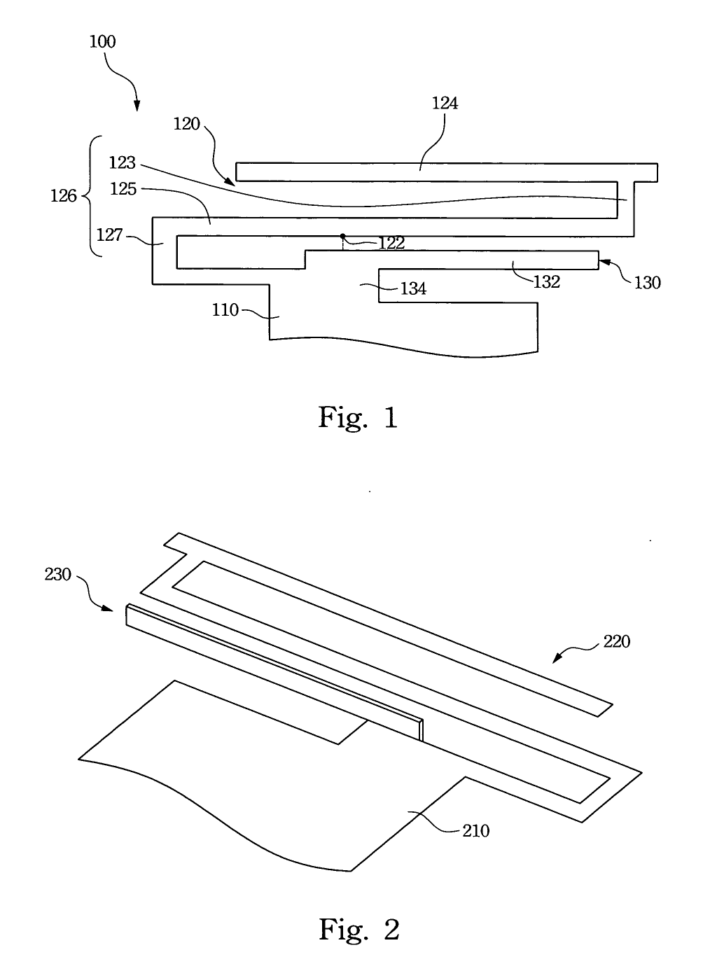

Reference is made to FIG. 1, which is a side view of an antenna according to one preferred embodiment of the present invention. As shown in FIG. 1, an antenna 100 includes a grounding element 110, a radiating element 120 and a coupling element 130. The radiating element 120 has a radiating part 124 and a connecting part 126. The connecting part 126 connects the grounding element 110 and the radiating part 124. The coupling element 130 extends from the grounding element 110, and the coupling element 130 is positioned between the radiating element 120 and the grounding element 110.

More specifically, a feed 122 may be disposed on the connecting part 126. The coupling element 130 overlaps the vertical projection of the feed 122 on the grounding element 110. When a current is fed into the radiating element 120, a residue current is generated on the vertical projection of the feed 122 on the grounding element 110. Thus, the radiating element 120 resonates with one band when the current passes through the radiating element 120, and the coupling element 130 can resonate with another band as well when the residue current passes through the coupling element 130.

In other words, the coupling element 130 is positioned near the feed 122 and on the grounding element 110. Similarly, when a current is fed into the radiating element 120, a residue current is generated somewhere near the feed 122 and on the grounding element 110. Thus, the radiating element 120 resonates with one band when the current passes through the radiating element 120, and the coupling element 130 can resonate with another band when the residue current passes through the coupling element 130.

As shown in FIG. 1, the coupling element 130 extends from the grounding element 110 towards the feed 122, and the coupling element 130 is partially parallel to the radiating element 120. More specifically, the coupling element 130 and the radiating element 120 are sheet structures, and the coupling element 130 and the radiating element 120 are substantially on one plane. However, according to another embodiment of the present invention, the coupling element may extend from the grounding element towards other directions. In other words, the radiating element is disposed on a first plane, and the coupling element is disposed substantially on a second plane. For example, the antenna shown in FIG. 2 has a radiating element 220 and a coupling element 230, wherein the radiating element 220 is disposed on a first plane, and the coupling element 230 is disposed substantially on a second plane. More specifically, an angle between the first plane of the radiating element 220 and the second plane of the coupling element 230 is about 90 degrees. Generically, as long as the coupling element is electrically connected to the residue current, generated on the grounding element, whether the shape, size or orientation of the coupling element is, the coupling element can resonate with another band without exception.

More specifically, the connecting part 126 may include a first portion 123, a second portion 127 and a third portion 125. The first portion 123 is mounted on the radiating part 124. The second portion 127 is mounted on the grounding element 110, and the second portion 127 is spaced from the first portion 123 at a desired distance. The third portion 125 connects the first portion 123 and the second portion 127. As shown in FIG. 1, the first portion 123 and the second portion 127 are substantially vertical relative to the radiating part 124 and the grounding element 110 respectively. The third portion 125 is substantially parallel to the radiating part 124. In other words, the third portion 125 is substantially vertical relative to the first portion 123 and the second portion 127. However, this should not limit the scope of the present invention, and the first portion, the second portion, the third portion and orientations thereof should depend on actual requirements.

In FIG. 1, the feed 122 is disposed on the third portion 125. The current may be fed into the radiating part 124 through the connecting part 126, or a signal may be fed from the radiating part 124 through the connecting part 126 because the feed 122 is disposed on the third portion 125. Moreover, the connecting part 126 may provide a ground function as well because the connecting part 126 electrically connects the radiating part 124 and the grounding element 110. More specifically, the current is divided into two branches, one of which passes through the first portion 123, and the other passes towards the second portion 127, when the current is fed into the radiating part 124 through the feed 122. The branch which passes towards the second portion 127 is stopped by a turning point between the third portion 125 and the second portion 127. The branch which passes towards the second portion 127 is then returned to the first portion 123. Therefore, almost all of the current is fed into the radiating part 124 to generate resonance. When the radiating part 124 receives an electromagnetic wave and then induces a signal, almost the entire signal is fed into a signal wire (not shown) through the feed 122 because the feed 122 is disposed on the front of the grounding element 110. In one word, the connecting part 126 provides both the ground function and the signal feeding function due to the turning point of the connecting part 126.

Refer to FIG. 1 continuously. The coupling element 130 includes a resonance element 132 and a connecting element 134. The connecting element 134 connects the resonance element 132 and the vertical projection of the feed 122 on the grounding element 110. The residue current generated on the vertical projection of the feed 122 on the grounding element 110 may be fed into the resonance element 132 through the connecting part 134. Thus, the resonance element 132 can resonate with another band. The resonance element 132 may be a conductive wire in this embodiment. However, this should not limit the scope of the present invention, and the resonance element may be a conductive sheet or a conductive material with other shapes.

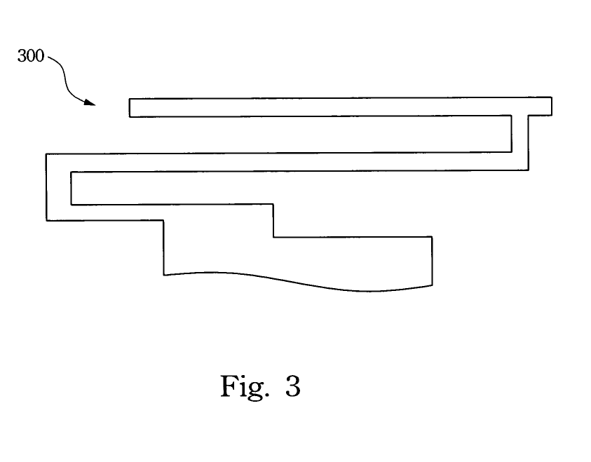

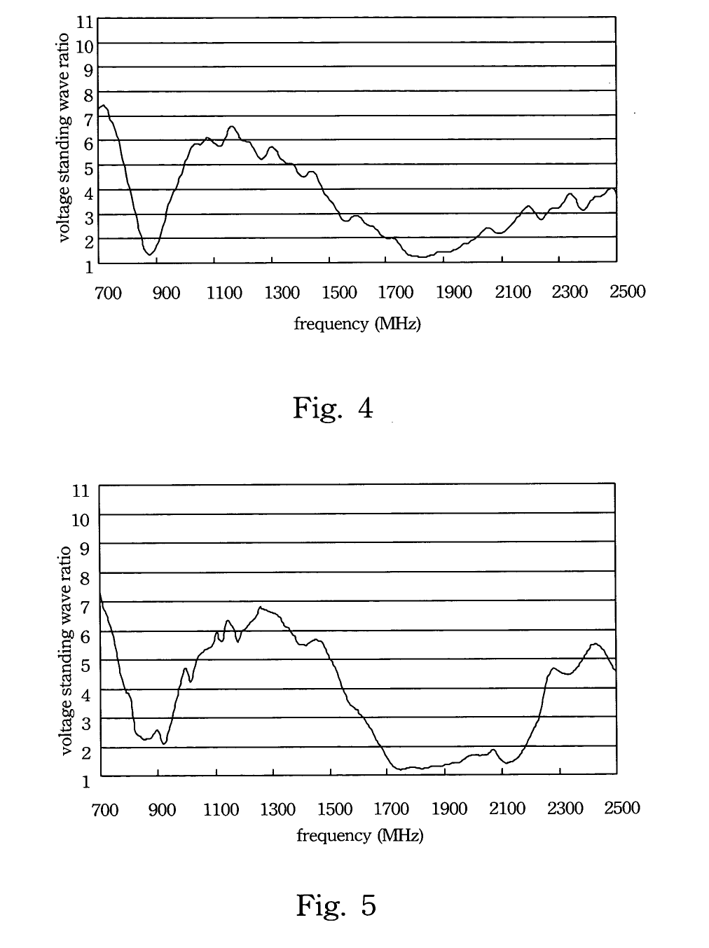

Reference is made to FIG. 4 and FIG. 5. FIG. 4 shows a curve of VSWR vs. frequency for the antenna 300 shown in FIG. 3. FIG. 5 shows a curve of VSWR vs. frequency for the antenna 100 shown in FIG. 1. Generally, the IEEE802.11b technology requires the VSWR should be less than 2. The VSWR of the antenna 100 is less than 2 when the working frequency of the antenna 100 is within 1.7-2.2 GHz. In other words, the antenna 100 with the coupling element 130 can be operated at 1.7-2.2 GHz. However, the VSWR of the antenna 300 is less than 2 only when the working frequency of the antenna 300 is within 1.7-2.02 GHz. Thus, the antenna 300 without the coupling element can be operated at 1.7-2.02 GHz only. That is, the antenna with the coupling element has a broader band at least in the high frequency part.

In conclusion, the invention has at least the following advantages:

(1) the antenna according to the mentioned embodiments of the invention has a broad band to be compatible with more wireless communication standards; and

(2) consumer electronic products with the antenna do not necessarily have plural antennas built therein due to the broad band of the antenna, and thus inference between the antennas no longer occurs.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An antenna comprising:
a grounding element;
a radiating element having a radiating part and a connecting part connecting the grounding element and the radiating part; and
a coupling element extending from the grounding element and positioned between the radiating element and the grounding element.

2. The antenna of claim 1, further comprising a feed disposed on the connecting part.

3. The antenna of claim 2, wherein the coupling element overlaps the vertical projection of the feed on the grounding element.

4. The antenna of claim 1, wherein the coupling element is partially parallel to the radiating element.

5. The antenna of claim 1, wherein the radiating element and the coupling element are substantially on one plane.

6. The antenna of claim 1, wherein the radiating element is disposed on a first plane, and the coupling element is disposed substantially on a second plane.

7. The antenna of claim 6, wherein an angle between the first plane of the radiating element and the second plane of the coupling element is about 90 degrees.

8. The antenna of claim 1, wherein the connecting part comprises:
a first portion mounted on the radiating part;
a second portion mounted on the grounding element and spaced from the first portion at a desired distance; and
a third portion connecting the first portion and the second portion.

9. The antenna of claim 8, further comprising a feed disposed on the third portion.

10. The antenna of claim 9, wherein the coupling element comprises:
a resonance element; and
a connecting element connecting the resonance element and the vertical projection of the feed on the grounding element.

11. The antenna of claim 10, wherein the resonance element is a conductive wire.

12. An antenna comprising:
a grounding element;
a radiating element having a radiating part and a connecting part connecting the grounding element and the radiating part;
a feed disposed on the connecting part; and
a coupling element extending from the grounding element and positioned near the feed.

13. The antenna of claim 12, wherein the coupling element is partially parallel to the radiating element.

14. The antenna of claim 12, wherein the radiating element and the coupling element are substantially on one plane.

15. The antenna of claim 12, wherein the radiating element is disposed on a first plane, and the coupling element is disposed substantially on a second plane.

16. The antenna of claim 15, wherein an angle between the first plane of the radiating element and the second plane of the coupling element is about 90 degrees.

17. The antenna of claim 12, wherein the connecting part comprises:
a first portion mounted on the radiating part;
a second portion mounted on the grounding element and spaced from the first portion at a desired distance; and
a third portion connecting the first portion and the second portion.

18. The antenna of claim 17, wherein the feed is disposed on the third portion.

19. The antenna of claim 12, wherein the coupling element comprises:
a resonance element; and
a connecting element connecting the resonance element and the vertical projection of the feed on the grounding element.

20. The antenna of claim 19, wherein the resonance element is a conductive wire.
